(19) United States
(12) Patent Application Publication
(10) Pub. No.: US 2007/0207373 A1
(43) Pub. Date: Sep. 6, 2007

(54) Solid oxide fuel cell cathode material

(76) Inventors: Timothy R. Armstrong, Clinton, TN (US); Edward A. Payzant, Oak Ridge, TN (US); Scott A. Speakman, Lowell, MA (US)

Correspondence Address: UT-Battelle, LLC;Office of Intellectual Property, One Bethal Valley Road, 4500N, MS-6258, Oak Ridge, TN, 37831, US

(21) Appl. No.: 11/369,087

(22) Filed: Mar. 6, 2006

(51) Int. Cl. H01M 4/90; H01M 8/12

(52) U.S. Cl. 429/40; 429/30

(57) ABSTRACT

A solid oxide fuel cell includes a porous anode, a dense electrolyte in contact with the porous anode, and a porous cathode in contact with the dense electrolyte. The porous cathode is characterized by a single-phase structure of Brownmillerite or Srebrodolskite, the composition thereof having the formula
(Ca₂₋ₓAₓ)(Fe_{2-y}B_{y})O_{5±z} wherein: A is at least one element selected from the group: rare earth elements, Bi, and alkaline elements; B is at least one element selected from the group: Al, Ga, In, Mg, Si, and transition metal elements; 0≦x<2; 0≦y<2; and z is a variable, the value of which is such that the overall composition has a generally neutral charge state.

The United States Government has rights in this invention pursuant to contract no. DE-AC05-00OR22725 between the United States Department of Energy and UT-Battelle, LLC.

### FIELD OF THE INVENTION

The present invention relates to solid oxide fuel cell (SOFC) cathode material compositions, and more particularly to SOFC cathode material compositions that contain Ca and Fe.

### BACKGROUND OF THE INVENTION

Devices commonly known as fuel cells comprise plates or tubes that directly convert to electricity the energy released by oxidation of hydrogen. Fuel cells offer the potential for a clean, quiet, and efficient power source for portable electric generation. Solid oxide fuel cells (SOFC), particularly tubular solid oxide fuel cells (TSOFC), are particularly attractive candidates for applications in distributed or centralized power applications.

SOFC technology has the potential for providing high power densities, long, stable performance lifetimes, the ability to utilize a broad source of fuels without expensive reforming or gas cleanup, and provide high system efficiencies for a wide range of power generation for transportation.

Initially, solid oxide fuel cells (SOFC) used lanthanum manganite (LSM) as the cathode—a good electron conductor, but a poor oxygen ion conductor. These electrodes are porous, up to 40% by volume and are placed adjacent to an yttria stabilized zirconia (YSZ) electrolyte. As the cathode is essentially only an electron conductor the reaction point where the oxygen molecule is ionized forming oxygen ions occurs at the point (triple point) where the air (pore), cathode (LSM) and electrolyte come together. In theory, the more points (higher surface area) the lower the interfacial polarization and the more efficient the ionization and exchange of oxygen. However, higher surface area cathodes tend to lead to increased in-plane resistance, higher polarization, and lower efficiency.

One route to improve upon the aforementioned problem is to alter the materials properties, introducing oxygen ion conductivity while maintaining electronic conduction, thus making the reaction point a reaction surface. In this case, oxygen is ionized and transported anywhere on the cathode surface-greatly reducing interfacial losses. This has been demonstrated with lanthanum ferrite and cobalt doped lanthanum ferrite.

At least one negative issue known to be associated with the use of the above-described materials is that they react with the zirconia electrolyte, forming unwanted insulating phases. Several other issues are the cost of La and that the oxygen ion conductivity is limited to less than 10% of the total conductivity. This is a constraint of the structure that has not been overcome by modifying the La-ferrite or La-magnetite compositions. Therefore, a new and different compositional approach is warranted.

U.S. Pat. No. 6,471,921 issued on Oct. 29, 2002 to Van Calcar, et al. entitled “Mixed Ionic and Electronic Conducting Ceramic Membranes for Hydrocarbon Processing” and U.S. Pat. No. 6,641,626 issued on Nov. 4, 2003 to Van Calcar, et al. entitled “Mixed Ionic and Electronic Conducting Ceramic Membranes for Hydrocarbon Processing” are referenced as relevant background information, the entire disclosures of which are incorporated herein by reference.

### OBJECTS OF THE INVENTION

Accordingly, objects of the present invention include provision of SOFC cathode material compositions at a potentially lower cost (because inexpensive, readily available materials are used in the composition), higher oxygen ion conductivity, and lower interfacial resistance under operating conditions. Further and other objects of the present invention will become apparent from the description contained herein.

### SUMMARY OF THE INVENTION

In accordance with one aspect of the present invention, the foregoing and other objects are achieved by a solid oxide fuel cell that includes a porous anode, a dense electrolyte in contact with the porous anode, and a porous cathode in contact with the dense electrolyte.

The porous cathode is characterized by a single-phase structure of Brownmillerite or Srebrodolskite, the composition thereof having the formula
(Ca₂₋ₓAₓ)(Fe_{2-y}B_{y})O_{5±z}

wherein:

A is at least one element selected from the group: rare earth elements, Bi, and alkaline elements;

B is at least one element selected from the group: Al, Ga, In, Mg, Si, and transition metal elements; 0≦x<2; 0≦y<2; and

z is a variable, the value of which is such that the overall composition has a generally neutral charge state.

### BRIEF DESCRIPTION OF THE DRAWINGS

FIG. 1 is an oblique, not-to-scale view of a fuel cell tube in accordance with the present invention.

FIG. 2 is a graph containing Arrhenius plots of total conductivity of various compositions in accordance with the present invention.

FIG. 3 is a graph containing Arrhenius plots of total conductivity of various compositions in accordance with the present invention.

FIG. 4 is a graph containing Arrhenius plots of total conductivity of various compositions in accordance with the present invention.

For a better understanding of the present invention, together with other and further objects, advantages and capabilities thereof, reference is made to the following disclosure and appended claims in connection with the above-described drawings.

### DETAILED DESCRIPTION OF THE INVENTION

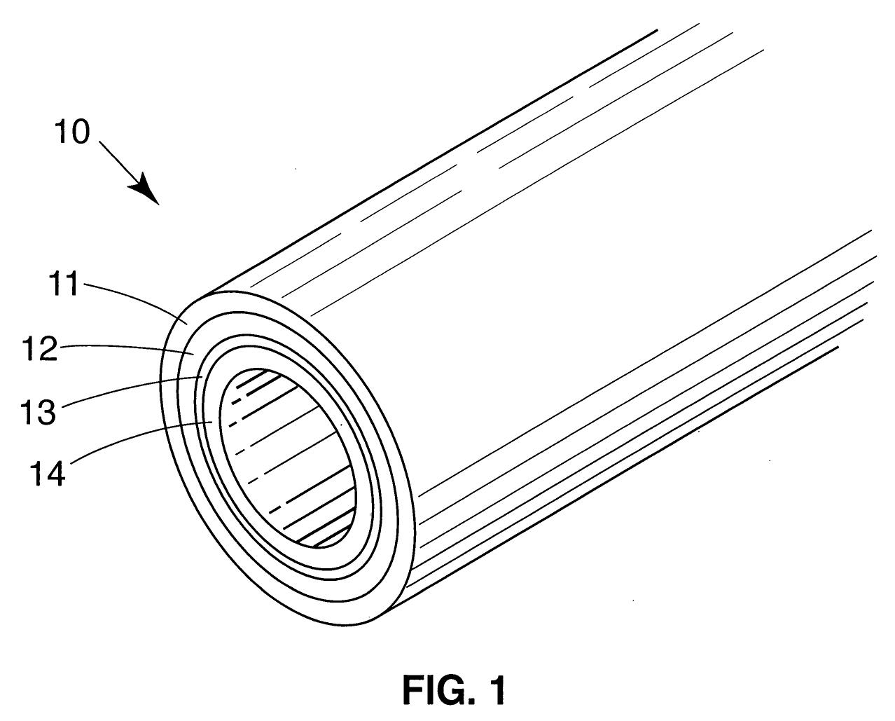

Referring to FIG. 1, an example of a TSOFC tube 10 having a circular cross-section is shown. The tube 10 is open on both ends. A porous metal support tube 11 is coated on the inside with a porous anode 12 such as Ni—Ni Yttria stabilized zirconia (YSZ), for example. The anode 12 is coated on the inside with a dense electrolyte 13 such as Y₂O₃—ZrO₂, for example. The dense electrolyte 13 is coated on the inside with a porous cathode 14, which is an oxygen ion conductor. The location of anode and cathode layers is interchangeable. Moreover, the fuel cell does not have to be tubular, many designs are planar, and some designs have various other geometric configurations.

In accordance with the present invention, the cathode 14 comprises at least one composition such as Ca₂Fe₂O₅ and related compositions having the general formula
(Ca₂₋ₓAₓ)(Fe_{2-y}B_{y})O_{5±z}

Wherein:

A (A-site dopant) is at least one element selected from the group: rare earth elements (La, Ce, Pr, Nd, Pm, Sm, Eu, Gd, Tb, Dy, Ho, Er, Tm, Yb, and Lu), Bi, and alkaline elements such as Ba, Sr, Y, Na, Li, or K, for example;

B (B-site dopant) is at least one element selected from the group: Al, Ga, In, Mg, Si, and transition metal elements (Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, and Hg);

0≦x<2 and 0≦y<2. Doping of at least one of the A site and the B site is optional. The value of z depends upon the values of x and y and the oxidation states of the Ca, A, Fe, and B elements. The value of z is such that the composition has a neutral charge state. In preferred materials, 0<z<1.

The morphology of new cathode material of the present invention is characterized by a single-phase structure that is an oxygen-deficient derivative of the perovskite structure, specifically either the Brownmillerite or the closely related Srebrodolskite structure.

The new cathode material of the present invention demonstrates high oxygen ion conductivity and when used as a cathode for a solid oxide fuel cell distributes the oxygen exchange from a single point to a three dimensional surface reducing interfacial polarization losses and improving fuel cell performance.

### EXAMPLE I

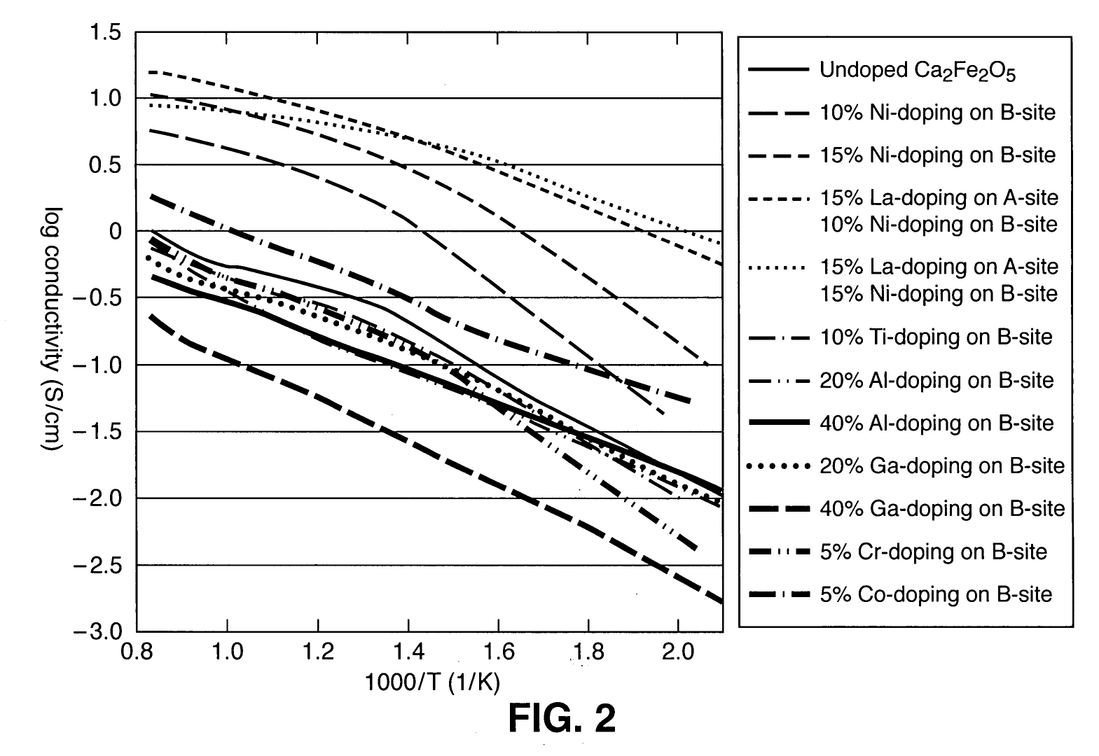

Total conductivity of (Ca₂₋ₓAₓ)(Fe_{2-y}B_{y})O_{5±d} was altered by A- and B-site doping of various samples:
10% Ni doping on the B-site
15% Ni doping on the B-site
15% La doping on the B-site and 10% Ni doping on the B-site
15% La doping on the B-site and 15% Ni doping on the B-site
10% Ti doping on the B-site
20% Al doping on the B-site
50% Al doping on the B-site
20% Ga doping on the B-site
40% Ga doping on the B-site
5% Cr doping on the B-site
5% Co doping on the B-site
FIG. 2 contains Arrhenius plots of total conductivity in air for undoped Ca₂Fe₂O₅ and the above-listed compositions.

FIG. 2 shows that the conductivity at 900° C. varies by 2 orders of magnitude depending on the doping scheme; the conductivity at 300° C. varies by almost 3 orders of magnitude depending on the doping scheme. Doping not only changes the overall conductivity, but also changes the contribution of different conduction mechanisms (electron, oxygen-ion, and proton) to the conductivity.

### EXAMPLE II

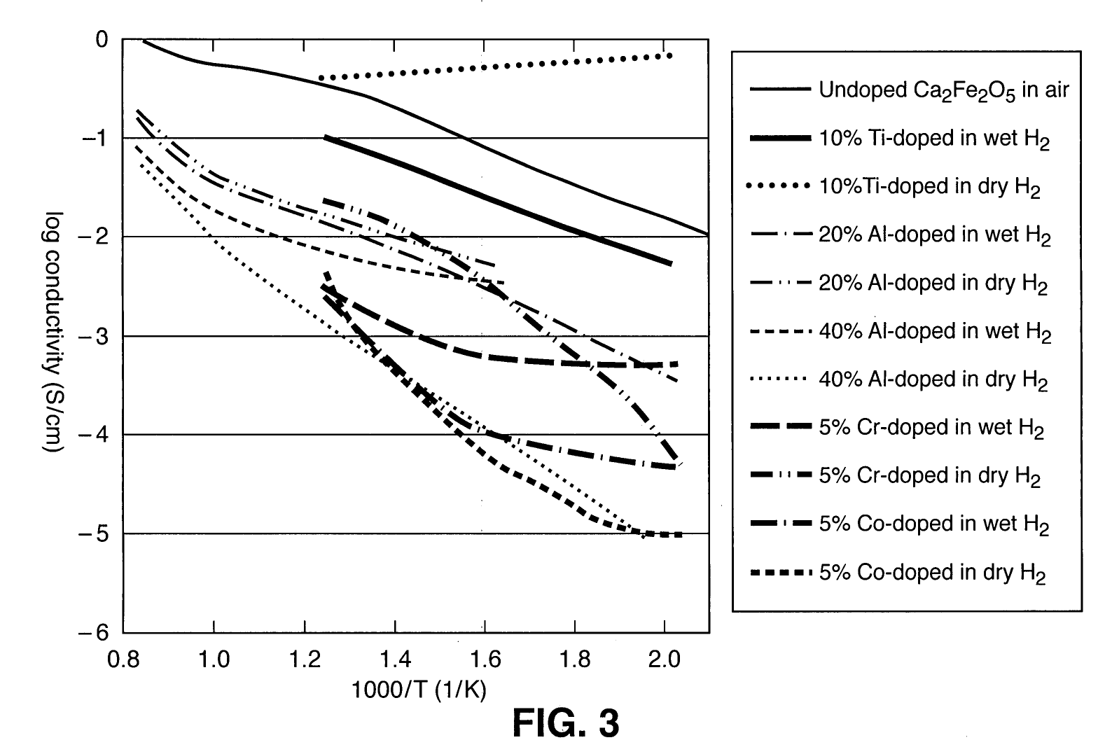

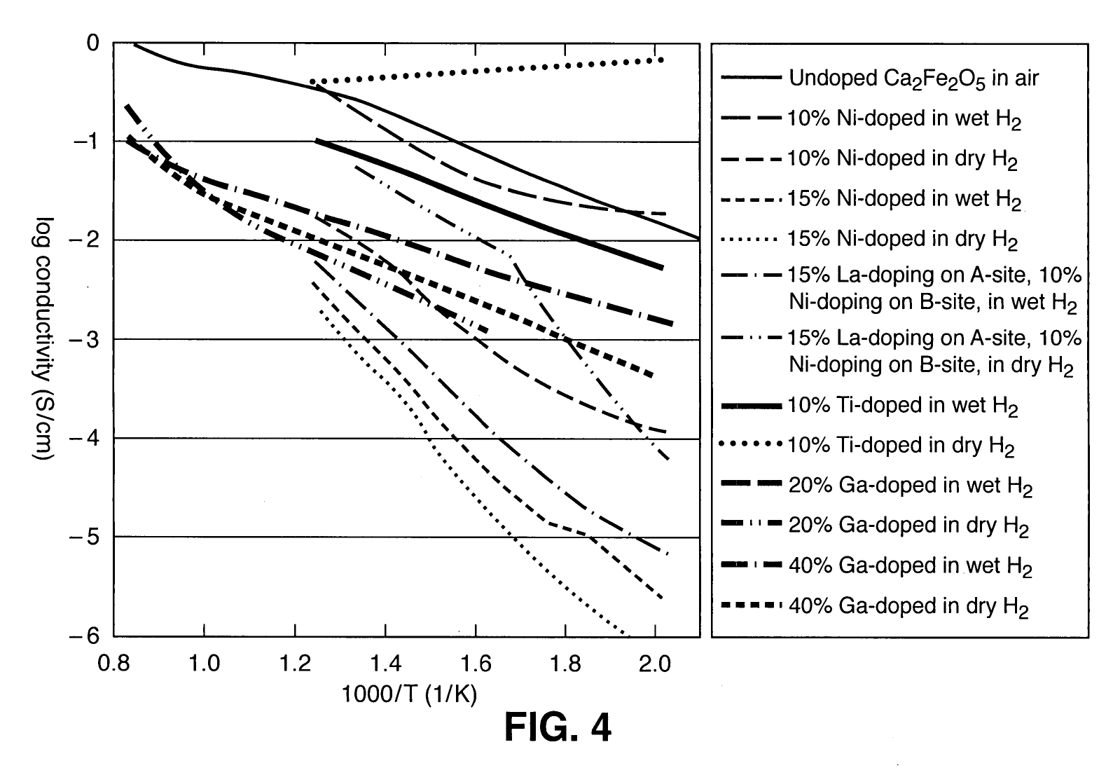

Total conductivity of (Ca₂₋ₓAₓ)(Fe_{2-y}B_{y})O_{5±d} was altered by A- and B-site doping of various samples and tested dry H₂ and humidified (wet) H₂:
10% Ti-doping on the B-site, in wet H₂
10% Ti-doping on the B-site, in dry H₂
20% Al-doping on the B-site, in wet H₂
20% Al-doping on the B-site, in dry H₂
40% Al-doping on the B-site, in wet H₂
40% Al-doping on the B-site, in dry H₂
5% Cr-doping on the B-site, in wet H₂
5% Cr-doping on the B-site, in dry H₂
5% Co-doping on the B-site, in wet H₂
5% Co-doping on the B-site, in dry H₂
10% Ni-doping on the B-site, in wet H₂
10% Ni-doping on the B-site, in dry H₂
15% Ni-doping on the B-site, in wet H₂
15% Ni-doping on the B-site, in dry H₂
15% La-doping on the A-site and 10% Ni-doping on the B-site, in wet H₂
15% La-doping on the A-site and 10% Ni-doping on the B-site, in dry H₂
10% Ti-doping on the B-site, in wet H₂
10% Ti-doping on the B-site, in dry H₂
20% Ga-doping on the B-site, in wet H₂
20% Ga-doping on the B-site, in dry H₂
40% Ga-doping on the B-site, in wet H₂
40% Ga-doping on the B-site, in dry H₂
Conductivity of undoped Ca₂Fe₂O₅ and the compositions listed above was tested in dry H₂ and humidified (wet) H₂. FIGS. 3 and 4 contain Arrhenius plots of total conductivity in wet and dry H₂ for undoped Ca₂Fe₂O₅ and the above-listed compositions. The dopants expressed in the legends are B-site dopants unless otherwise specified.

FIGS. 3 and 4 show that the presence of water vapor in the H₂ gas promotes proton conduction. Significant variations in Arrhenius behavior in wet and dry H₂ was observed, dependent on the doping scheme.

It will be apparent to the skilled artisan that, in view of Examples I and II, other A- and B-site dopants that have been contemplated, as listed hereinabove, will produce operable embodiments of the present invention.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A solid oxide fuel cell comprising a porous anode, a dense electrolyte in contact with said porous anode, and a porous cathode in contact with said dense electrolyte, said porous cathode being characterized by a single-phase structure selected from the group consisting of Brownmillerite and Srebrodolskite, said porous cathode consisting essentially of a composition having the formula
(Ca₂₋ₓAₓ)(Fe_{2-y}B_{y})O_{5±z}
wherein:
a. A is at least one dopant element selected from the group consisting of: rare earth elements, Bi, and alkaline elements;
b. B is at least one dopant element selected from the group consisting of: Al, Ga, In, Mg, Si, and transition metal elements;
c. 0≦x<2;
d. 0≦y<2; and
e. z is a variable, the value of which is such that said composition has a generally neutral charge state.

2. A solid oxide fuel cell in accordance with claim 1 wherein A consists essentially of La.

3. A solid oxide fuel cell in accordance with claim 1 wherein B consists essentially of an element selected from the group consisting of: Al, Co, Cr, Ga, Ni, and Ti.

4. A solid oxide fuel cell in accordance with claim 1 wherein 0<z<1.
